(19) United States
(12) Patent Application Publication
(10) Pub. No.: US 2026/0265154 A1
(43) Pub. Date: Sep. 10, 2026

(54) OXIDATIVE RESISTANCE OF CARBON-CARBON COMPOSITES FOR PISTON SEALS IN A GAS TURBINE ENGINE

(71) Applicant: RTX Corporation, Farmington, CT (US)

(72) Inventors: Xiaomei Fang, South Glastonbury, CT (US); Calvin Jay Winder, Cromwell, CT (US); Benjamin Schafer, East Hartford, CT (US)

(73) Assignee: RTX Corporation, Farmington, CT (US)

(21) Appl. No.: 19/075,081

(22) Filed: Mar. 10, 2025

(51) Int. Cl. C04B 41/00; C04B 35/83; C04B 41/45; C04B 41/80

(52) U.S. Cl. CPC C04B 41/0054; C04B 35/83; C04B 41/0072; C04B 41/4515; C04B 41/4535; C04B 41/80; C04B 2235/422; C04B 2235/5248

(57) ABSTRACT

A process of treating a carbon-carbon composite material including modifying a surface of the carbon-carbon composite material to increase a hydrophilic surface functionality; applying a plasma surface treatment to the carbon-carbon composite material; infiltrating the carbon-carbon composite with an oxidation inhibiting composition; and heating the carbon-carbon composite at a predetermined temperature sufficient to form a deposit from the oxidation inhibiting composition in at least some pores of the carbon-carbon composite.

### BACKGROUND

The present disclosure is directed to a carbon-carbon composite gas turbine component with improved oxidative resistance by activating and functionalizing a carbon-carbon surface to enhance infiltration of mono-aluminum phosphate treatment into the gas turbine component.

A gas turbine engine includes a rotor rotatable about an engine central axis. The rotor can define a seal surface. A shaft is rotatable about the engine central axis and defines an annular seal channel that opens to the seal surface. A seal can be disposed in the annular seal channel for sealing against the seal surface.

The seal can be produced from a carbon fiber reinforced graphite matrix material, also called carbon-carbon composite. A carbon-carbon composite seal offers superior wear resistance, lighter weight and lower friction relative to a metal seal.

However, carbon-carbon composite material often contains 5 to 15% open porosity. Air can infiltrate into an inner section of a carbon-carbon bulk composite material through open pores under high pressure in service conditions. Such air channels may induce internal oxidation in the bulk carbon-carbon composite and accelerate oxidation damage.

Carbon-carbon composites are often treated with mono-aluminum phosphates (MALP) to prevent oxidation damage. One method of MALP application includes immersing the carbon-carbon composite in a solution of phosphoric acid and aluminum hydroxide. Then the carbon-carbon composite gets dried and then baked up to 1,200 to 2,000 degrees Fahrenheit.

However, open pore size in carbon-carbon composites can vary significantly prior to MALP immersion. Carbon material in open pores are often hydrophobic in nature and MALP solution is difficult to infiltrate into fine pores. Insufficient MALP coverage over the open pores can reduce oxidation resistance of carbon-carbon composites.

### SUMMARY

In accordance with the present disclosure, there is provided a process of treating a carbon-carbon composite material comprising modifying a surface of the carbon-carbon composite material to increase a hydrophilic surface functionality; applying a plasma surface treatment to the carbon-carbon composite material; infiltrating the carbon-carbon composite with an oxidation inhibiting composition; and heating the carbon-carbon composite at a predetermined temperature sufficient to form a deposit from the oxidation inhibiting composition in at least some pores of the carbon-carbon composite.

A further embodiment of any of the foregoing embodiments may additionally and/or alternatively include the plasma surface treatment is applied to the carbon-carbon composite prior to application of the oxidation inhibiting composition.

A further embodiment of any of the foregoing embodiments may additionally and/or alternatively include the plasma surface treatment is applied to the carbon-carbon composite via a low-pressure plasma chamber.

A further embodiment of any of the foregoing embodiments may additionally and/or alternatively include both argon and air are employed in the plasma surface treatment.

A further embodiment of any of the foregoing embodiments may additionally and/or alternatively include the process further comprising exposing the surface of the carbon-carbon composite material for one to five minutes to an argon gas; and exposing the surface of the carbon-carbon composite material for five to twenty minutes to air.

A further embodiment of any of the foregoing embodiments may additionally and/or alternatively include the argon gas is used to clean off the surface of the carbon-carbon composite material, and the air is used to oxidize the surface of the carbon-carbon composite material and to modify a surface functionality from hydrophobic to hydrophilic to achieve a higher surface tension on the surface of the carbon-carbon composite material.

A further embodiment of any of the foregoing embodiments may additionally and/or alternatively include a ballistic water contact angle of the surface of the carbon-carbon composite material is reduced from 50 degrees-70 degrees prior to the plasma surface treatment to 2 degrees-20 degrees post plasma surface treatment.

In accordance with the present disclosure, there is provided a carbon-carbon composite material treated with a plasma surface treatment prior to applying an oxidation inhibiting composition, the treatment comprising modifying a surface of the carbon-carbon composite material to increase a hydrophilic surface functionality; applying a plasma surface treatment to the carbon-carbon composite material; infiltrating the carbon-carbon composite with an oxidation inhibiting composition; and heating the carbon-carbon composite at a predetermined temperature sufficient to form a deposit from the oxidation inhibiting composition in at least some pores of the carbon-carbon composite.

A further embodiment of any of the foregoing embodiments may additionally and/or alternatively include the plasma surface treatment is applied to the carbon-carbon composite prior to application of the oxidation inhibiting composition.

A further embodiment of any of the foregoing embodiments may additionally and/or alternatively include both argon and air are employed in the plasma surface treatment.

A further embodiment of any of the foregoing embodiments may additionally and/or alternatively include the carbon-carbon composite material further comprising exposing the surface of the carbon-carbon composite material for one to five minutes to an argon gas; and exposing the surface of the carbon-carbon composite material for five to twenty minutes to air.

A further embodiment of any of the foregoing embodiments may additionally and/or alternatively include the plasma surface treatment is combined with multiple oxidation inhibiting composition infiltration steps and vacuum processes to accelerate the oxidation inhibiting composition solution coverage on open pores of the surface and enhance oxidation resistance of the carbon-carbon composite material.

A further embodiment of any of the foregoing embodiments may additionally and/or alternatively include a ballistic water contact angle of the surface of the carbon-carbon composite material is reduced from 50 degrees-70 degrees prior to the plasma surface treatment to 2 degrees-20 degrees post plasma surface treatment.

In accordance with the present disclosure, there is provided a process for treating a gas turbine engine component made from a carbon-carbon composite material comprising modifying a surface of the carbon-carbon composite material to increase a hydrophilic surface functionality; applying a plasma surface treatment to the carbon-carbon composite material; infiltrating the carbon-carbon composite component with an oxidation inhibiting composition; and heating the carbon-carbon composite component at a predetermined temperature sufficient to form a deposit from the oxidation inhibiting composition in at least some pores of the carbon-carbon composite component.

A further embodiment of any of the foregoing embodiments may additionally and/or alternatively include the plasma surface treatment is applied to the carbon-carbon composite prior to application of the oxidation inhibiting composition.

A further embodiment of any of the foregoing embodiments may additionally and/or alternatively include the process further comprising exposing the surface of the carbon-carbon composite material component for one to five minutes to an argon gas; and exposing the surface of the carbon-carbon composite material component for five to twenty minutes to air.

A further embodiment of any of the foregoing embodiments may additionally and/or alternatively include the process further comprising reducing a ballistic water contact angle of the surface of the carbon-carbon composite material component from 50 degrees-70 degrees prior to the plasma surface treatment to 2 degrees-20 degrees post plasma surface treatment.

A further embodiment of any of the foregoing embodiments may additionally and/or alternatively include the process further comprising combining the plasma surface treatment with multiple oxidation inhibiting composition infiltration steps and vacuum processes to accelerate the oxidation inhibiting composition solution coverage on open pores of the surface and enhance oxidation resistance of the carbon-carbon composite material.

A further embodiment of any of the foregoing embodiments may additionally and/or alternatively include the process further comprising employing both argon and air in the plasma surface treatment.

A further embodiment of any of the foregoing embodiments may additionally and/or alternatively include the process further comprising drying the carbon-carbon composite material component.

The activation and preferred functionalities of a carbon-carbon surface can be achieved by low pressure or atmospheric pressure plasma surface treatment under specific conditions. Ozone or corona surface treatments can be applied to activate and modify surface functionality as well.

Other details of the process are set forth in the following detailed description and the accompanying drawings wherein like reference numerals depict like elements.

### BRIEF DESCRIPTION OF THE DRAWINGS

The above and further advantages of this disclosure may be better understood by referring to the following description in conjunction with the accompanying drawings, in which like reference numerals indicate like elements and features in the various figures. Letters may be appended to reference numbers to distinguish from reference numbers for similar features and to indicate a correspondence to other features in the drawings. For clarity, not every element may be labeled in every figure. The drawings are not necessarily to scale, emphasis instead being placed upon illustrating the principles of the disclosure.

FIG. 1 is a process map of the exemplary process.

FIG. 2 is a diagram illustrating accelerated infiltration of MALP into carbon-carbon voids via plasma surface treatment.

### DETAILED DESCRIPTION

The term “retention” refers to reducing or preventing the migration of a material from inside the pores of a carbon-carbon composite out of the pores and onto a surface, for example, in response to heating or ambient humidity. The terms “impregnate,” “penetrate,” and their derivatives refer to a situation where materials infiltrate or flow into the pores of a porous material. The pores may be in the carbon-carbon composite, a barrier coating overlying the carbon-carbon composite, or a combination thereof.

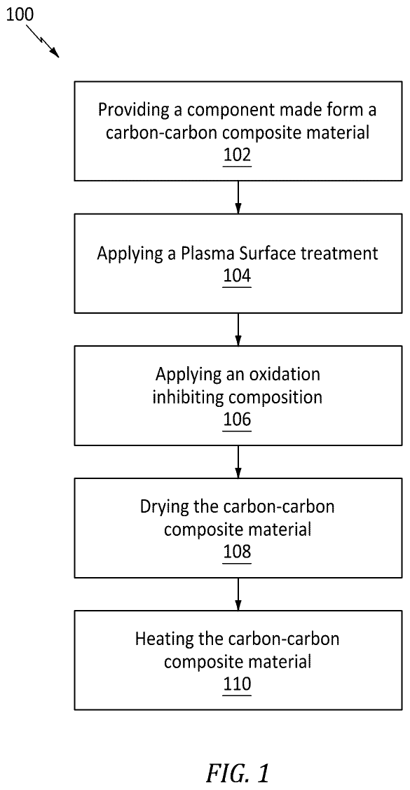

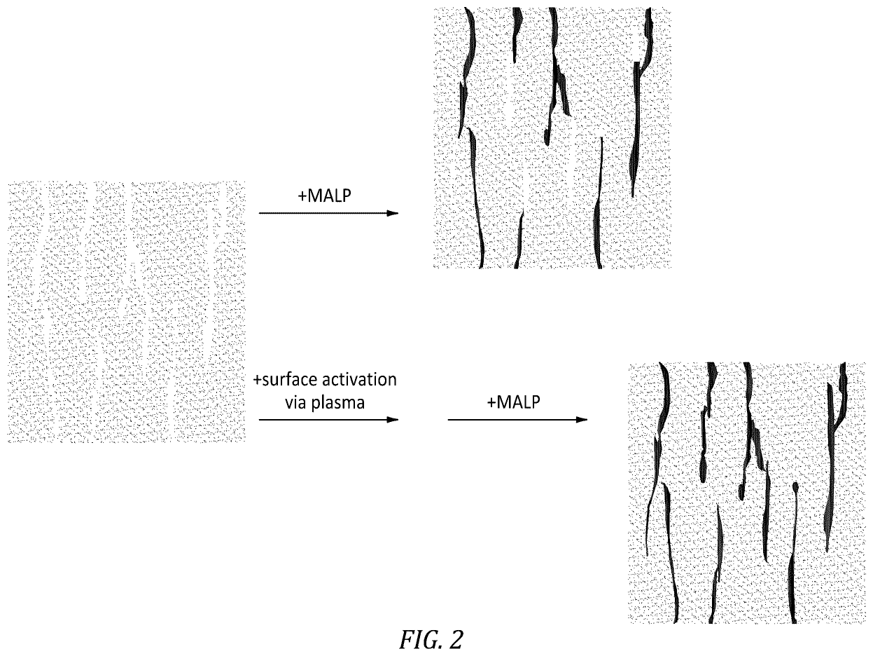

Referring to FIG. 1 and FIG. 2, an exemplary process map is shown. The exemplary process 100 shown in FIG. 1 includes at step 102, providing a component made from a carbon-carbon composite material. Step 104 includes applying a plasma surface treatment to the carbon-carbon composite material. Step 106 includes applying an oxidation inhibiting composition to the surface of the carbon-carbon composite material. Step 108 includes drying the carbon-carbon composite material. Step 110 includes heating the carbon-carbon composite material. Further details of the process 100 are described in more detail.

The carbon-carbon composites that may be treated in accordance with the disclosed process may be any carbon-carbon composite. The carbon-carbon composites may be prepared from carbon preforms. Carbon preforms may be made of carbon fibers, which may be formed from pre-oxidized acrylonitrile resin. In one embodiment, these fibers can be layered together to form a shape, such as a seal. The shape is heated and infiltrated with a pyrolyzable carbon source, such as methane, to form the carbon-carbon composite. The carbon-carbon composite may have a bulk density in the range from about 1.5 g/cm3 to about 2.0 g/cm3.

In one embodiment, the carbon-carbon composites may contain catalytic materials in their pores that increase the rate of oxidation of such composites. These catalytic materials may not be present at manufacture. However in one embodiment, contaminating materials that may be present at manufacture may be passivated prior to use using the inventive method. Whether the contaminating materials are present during manufacture, or are introduced after manufacture, a list of these contaminating materials may include calcium, sodium, potassium, copper, iron, and vanadium. These contaminating materials may also include other metals or materials encountered during service (e.g., ozone) or organic material.

In one embodiment, a barrier coating may be applied to at least one surface of the carbon-carbon composite prior to or subsequent to treatment with the oxidation inhibiting composition pursuant to the inventive method. The barrier coating materials that may be used may be carbides or nitrides including boron nitride, silicon carbide, titanium carbide, boron carbide, silicon oxycarbide, silicon nitride, and mixtures of two or more thereof.

The barrier coating may be applied to the carbon-carbon composite using any known method, including chemical vapor deposition (CVD), painting, spraying, molten application, and the like. In one embodiment, the carbon-carbon composite may have a silicon carbide-based coating prepared by CVD. In one embodiment, the barrier coating may be painted (brushed or sprayed) onto a surface, such as ZYP COATING (grade SC), ZYP Coatings, Inc. (Oak Ridge, Tenn.). The paint may be baked to a temperature of about 650° C., either before or after the pores of the carbon-carbon composite are treated with the oxidation inhibiting composition pursuant to the disclosed process. In one embodiment, the barrier coating may be formed by treating the carbon-carbon composite with molten silicon. The molten silicon is reactive and may form a silicon carbide barrier on the carbon-carbon composite surface. This type of barrier coating may be referred to as a reaction formed barrier coating.

In one embodiment, the barrier coating may be porous, and the pores may be continuous, interconnected, or otherwise open to define pathways leading from a barrier coating surface into the barrier coating body. The porosity may be in the range from about 8 volume percent to about 13 volume percent. The porosity can be measured by displacement in a liquid, such as ISOPAR-M, under vacuum.

The disclosed process is useful in treating porous carbon-carbon composites whether or not a barrier coating has been applied to the composite. These composites may contain catalytic materials in their pores as indicated above. In embodiments wherein the barrier coating has not been applied, the oxidation inhibiting composition penetrates the pores of the carbon-carbon composite. In embodiments wherein the barrier coating has been applied, the oxidation inhibiting composition penetrates the pores of the barrier coating. A barrier coating can be applied to the carbon-carbon composite subsequent to being treated with the oxidation inhibiting composition.

The disclosed process comprises contacting or treating the carbon-carbon composite with the oxidation inhibiting composition and then heating the composite at a temperature sufficient to form a deposit from the oxidation inhibiting composition in at least some, and in one embodiment most or all, of the pores of the carbon-carbon composite. The contacted or treated carbon-carbon composite may be heated to a first, lower temperature (for example, about 30° C. to about 200° C.) to bake or dry the oxidation inhibiting composition. This step can be used when the oxidation inhibiting composition contains a volatile liquid. This step may be used to fix the oxidation inhibiting composition at a particular predetermined depth in the pores. A second, higher temperature (for example, about 200° C. to about 1000° C.) may then be used to form a deposit from the oxidation inhibiting composition within the pores of the carbon-carbon composite.

In one embodiment, the oxidation inhibiting composition may be applied to preselected regions of a carbon-carbon composite that may be otherwise susceptible to oxidation. For example, aerospace piston seal rings may have the oxidation inhibiting composition applied to the seal surfaces.

During application of the oxidation inhibiting composition, the oxidation inhibiting composition may be applied to the carbon-carbon composite by painting, dipping, spraying, CVD, or other application methods, selected with reference to application specific criteria. This criteria may include, viscosity, end-use, economic consideration, ingredients used, depth of penetration desired, and the like.

The oxidation inhibiting composition may be applied to the carbon-carbon composite at a coat weight in the range from about 10 mg/cm2 to about 60 mg/cm2, and in one embodiment from about 15 mg/cm2 to about 50 mg/cm2, and in one embodiment from about 20 mg/cm2 to about 40 mg/cm2, and in one embodiment from about 20 mg/cm2 to about 30 mg/cm2. In one embodiment, the oxidation inhibiting composition may be applied to the carbon-carbon composite at a coat weight of up to about 10 mg/cm2. In one embodiment, the oxidation inhibiting composition may be applied to the carbon-carbon composite at a coat weight of at least about 60 mg/cm2.

In one embodiment, the oxidation inhibiting composition may be applied to provide a solids treatment level, or dry film, in the range from about 2.5 mg/cm2 to about 15 mg/cm2; and in one embodiment from about 5 mg/cm2 to about 12.5 mg/cm2, and in one embodiment from about 6 mg/cm2 to about 10 mg/cm2.

The treatment level or amount of solids of the oxidation inhibiting composition that is applied may be selected to provide for filling of open pores in the carbon-carbon composite at a predetermined depth of penetration. The depth of penetration may be selected with reference to the depth suitable for complete oxidation protection and may be further selected with reference to amount that may avoid excessive penetration onto a wearing surface of the seal. In one embodiment, the preselected depth may be in the range of from 2.5 millimeters (about 0.1 inch) to about 5 millimeters (about 0.2 inch), and in one embodiment, the preselected depth may be in a range of less than about 2.5 millimeters (about 0.1 inch). In one embodiment, the preselected depth may be greater than about 5 millimeters (about 0.2 inch). Differing factors may be controlled to achieve the desired depth of penetration. Among the factors that may be controlled are the viscosity of the oxidation inhibiting composition, the coat weight, the soak or contact time of the oxidation inhibiting composition to the carbon-carbon composite prior to drying, the drying temperature, the pore size and porosity of the carbon-carbon composite, the chemical structure of the wetting agent and/or surfactant and others.

In one embodiment, the deposits may be uniformly distributed in the pores, e.g. with less than about 1 millimeter of separation between deposits. The deposits may be disposed, lodged or formed at a depth sufficient to provide oxidation protection to the carbon-carbon composites. In one embodiment, the deposits may be disposed at a depth in a range from about 2 millimeters to about 10 millimeters.

The treated carbon-carbon composites may be dried and/or heated to remove liquid from the oxidation inhibiting composition in embodiments wherein the oxidation inhibiting composition contains liquid, for example, water, a nonaqueous polar liquid, or a mixture thereof. This drying or heating step is optional. This drying or heating step may be conducted at a temperature in the range of about 30° C. to about 200° C. Drying may be distinguished from dehydration in that water may be present both in a free state and in a bound state. Some oxidation inhibiting compositions may be aqueous solutions or slurries and may have free water as a carrier liquid. Some of the oxidation inhibiting composition ingredients may have water in a bound, hydrating form. Drying removes free water from an aqueous solution or slurry, while dehydrating removes hydrated water.

The treated carbon-carbon composite may be heated, that is dried or baked, at a temperature in the range from about 200° C. to about 1000° C., and in one embodiment about 600° C. to about 1000° C. In one embodiment, this heating step may be conducted at a temperature in the range of about 200° C. to about 900° C., and in one embodiment about 400° C. to about 850° C. The heating step may be performed in an inert environment, such as under a blanket of inert gas (e.g., nitrogen, argon, and the like). The heating step may be conducted for a period from about 0.5 hour up to about 8 hours. In one embodiment, the carbon-carbon composites may be subjected to multiple treatment cycles. For example, from about 2 to about 4 treatment cycles may be used. The drying time and temperature are among the factors that may be controlled to determine the depth of penetration of the oxidation inhibiting composition in the carbon-carbon composite pores.

The carbon-carbon composite can be subjected to a plasma surface treatment prior to the application of the oxidation inhibiting composition to aid in the penetration of the oxidation inhibiting composition.

Plasma surface treatment can be applied to the carbon-carbon composite prior to application of the oxidation inhibiting composition, via a low-pressure plasma chamber. Both argon and air can be used in the plasma process. One example of a plasma treatment step includes 1 to 5 minutes in argon plus 5 to 20 minutes in air. Argon is used to clean off the carbon-carbon surface, and air is used to oxidize carbon-carbon surface and modify surface functionality from hydrophobic to hydrophilic to achieve a higher surface tension.

As a result, a ballistic water contact angle can be reduced from about 50 degrees to 70 degrees prior to plasma to 2 degrees to 20 degrees post plasma surface treatment. Lower water contact angles indicate higher surface tension and allow application of the oxidation inhibiting composition solution to infiltrate into the carbon-carbon composite fine pores easily under a capillary effect and thus increase the oxidation inhibiting composition coverage on open pores to enhance oxidation resistance.

Other surface treatment methods can also be applied, such as atmospheric plasma treatment or ozone treatment, ozone combined with ultraviolet treatment, or corona treatment to achieve higher surface tension and enhance the wetting of the oxidation inhibiting composition solutions. Plasma surface treatment can also be combined with multiple oxidation inhibiting composition infiltration steps and vacuum processes to accelerate the oxidation inhibiting composition solution coverage on open pores and enhance oxidation resistance of carbon-carbon composite parts.

In one embodiment, the carbon-carbon composite may be pretreated or warmed prior to application of the oxidation inhibiting composition to aid in the penetration of the oxidation inhibiting composition. The heat treatment may be for a period of about 2 hours at a temperature of about 760° C. The treated carbon-carbon composite may be dried or baked in a non-oxidizing, inert atmosphere, e.g., nitrogen (N2), to optimize the retention of the oxidation inhibitors in the pores. This retention may be improved by heating the carbon-carbon composite to about 200° C. and maintaining the temperature for about 1 hour before heating the carbon-carbon composite to a temperature in the range described above at a rate that removes water without boiling and provides temperature uniformity throughout the load of the carbon-carbon composite. In one embodiment, the maximum temperature may be held for a time sufficient to obtain temperature uniformity throughout the carbon-carbon composite.

The oxidation inhibiting composition may comprise: water, a nonaqueous polar liquid, or a mixture thereof; phosphoric acid or an acid phosphate salt; an aluminum salt; and at least one additional metal salt.

A solution of orthophosphoric acid may be used as a source for the phosphoric acid. The acid phosphate salt may be an ammonium phosphate. The acid phosphate salt may comprise ammonium dihydrogen phosphate or ammonium hydrogen phosphate. The phosphoric acid or acid phosphate salt may be present in the oxidation inhibiting composition at a concentration in the range from about 15 weight percent to about 70 weight percent, and in one embodiment from about 15 weight percent to about 35 weight percent, and in one embodiment about 20 to about 30 weight percent.

The aluminum salt may be an aluminum halide, aluminum nitrate, aluminum phosphate, aluminum sulfate, or a mixture of two or more thereof. A suitable aluminum halide may be aluminum chloride. In one embodiment, the aluminum salt may be an aluminum phosphate. A suitable aluminum phosphate may be mono-aluminum phosphate (Al(H2PO4)3), which is sometimes referred to as MALP, and which is commonly available as an about 50 weight percent concentration solution. In one embodiment, this solution may be present in the oxidation inhibiting composition at a concentration of about 37 to about 52 weight percent. Suitable aluminum salts also include aluminum salts that form an aluminum phosphate in response to outside stimulus, such as heating. The aluminum salt may be present in the oxidation inhibiting composition at a concentration in the range from about 10 weight percent to about 50 weight percent, and in one embodiment from about 15 weight percent to about 30 weight percent.

The cation of the additional metal salt may be multivalent. The metal may be an alkaline earth metal or a transition metal. The multivalent cation may be derived from a non-metallic element such as boron. The term “metal” is used herein to include multivalent elements such as boron that are technically non-metallic. The metal of the additional metal salt may be an alkaline earth metal such as calcium, magnesium, strontium, barium, or a mixture of two or more thereof. The metal for the additional metal salt may be iron, manganese, tin, zinc, or a mixture of two or more thereof. The anion for the additional metal salt may be an inorganic anion such as a phosphate, halide, sulfate or nitrate, or an organic anion such as acetate. In one embodiment, the additional metal salt may be an alkaline earth metal salt such as an alkaline earth metal phosphate. In one embodiment, the additional metal salt may be a magnesium salt such as magnesium phosphate. In one embodiment, the additional metal salt may be an alkaline earth metal nitrate, an alkaline earth metal halide, an alkaline earth metal sulfate, an alkaline earth metal acetate, or a mixture of two or more thereof. In one embodiment, the additional metal salt may be magnesium nitrate, magnesium halide, magnesium sulfate, or a mixture of two or more thereof. In one embodiment, the additional metal salt may comprise: (i) magnesium phosphate; and (ii) a magnesium nitrate, magnesium halide, magnesium sulfate, or a mixture of two or more thereof.

The additional metal salt may be selected with reference to its compatibility with other ingredients in the oxidation inhibiting composition. Compatibility may include metal phosphates that do not precipitate, flocculate, agglomerate, react to form undesirable species, or settle out prior to application of the oxidation inhibiting composition to the carbon-carbon composite. The phosphates may be monobasic (H2PO4-), dibasic (HPO4-2), or tribasic (PO4-3). The phosphates may be hydrated. Examples of alkaline earth metal phosphates that may be used include calcium hydrogen phosphate (calcium phosphate, dibasic), calcium phosphate tribasic octahydrate, magnesium hydrogen phosphate (magnesium phosphate, dibasic), magnesium phosphate tribasic octahydrate, strontium hydrogen phosphate (strontium phosphate, dibasic), strontium phosphate tribasic octahydrate and barium phosphate.

In one embodiment, a chemical equivalent of the additional metal salt may be used as the additional metal salt. Chemical equivalents include compounds that yield an equivalent (in this instance, an equivalent of the additional metal salt) in response to an outside stimulus such as, temperature, hydration, or dehydration. For example, equivalents of alkaline earth metal phosphates may include alkaline earth metal pyrophosphates, hypophosphates, hypophosphites and orthophosphites. Equivalent compounds include magnesium and barium pyrophosphate, magnesium and barium orthophosphate, magnesium and barium hypophosphate, magnesium and barium hypophosphite, and magnesium and barium orthophosphite.

A technical advantage of the disclosed process includes carbon-carbon composite piston seals that provide superior wear resistance, are light weight and low friction relative to metal seals.

Another technical advantage of the disclosed process includes the incorporation of plasma surface treatment prior to application of the oxidation inhibiting composition increases infiltration into fine pores of carbon-carbon composite and increases oxidation resistance.

Another technical advantage of the disclosed process includes application of the plasma surface treatment demonstrates over 35% less weight loss of the oxidation inhibiting composition treated carbon-carbon composite at 850 F for 2,500 hours.

There has been provided a process of plasma surface treatment prior to application of the oxidation inhibiting composition. While the process has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A process of treating a carbon-carbon composite material comprising:
modifying a surface of the carbon-carbon composite material to increase a hydrophilic surface functionality;
applying a plasma surface treatment to the carbon-carbon composite material;
infiltrating the carbon-carbon composite with an oxidation inhibiting composition; and
heating the carbon-carbon composite at a predetermined temperature sufficient to form a deposit from the oxidation inhibiting composition in at least some pores of the carbon-carbon composite.

2. The process according to claim 1, wherein the plasma surface treatment is applied to the carbon-carbon composite prior to application of the oxidation inhibiting composition.

3. The process according to claim 2, wherein the plasma surface treatment is applied to the carbon-carbon composite via a low-pressure plasma chamber.

4. The process according to claim 2, wherein both argon and air are employed in the plasma surface treatment.

5. The process according to claim 1, further comprising:
exposing the surface of the carbon-carbon composite material for one to five minutes to an argon gas; and
exposing the surface of the carbon-carbon composite material for five to twenty minutes to air.

6. The process according to claim 5, wherein the argon gas is used to clean off the surface of the carbon-carbon composite material, and the air is used to oxidize the surface of the carbon-carbon composite material and to modify a surface functionality from hydrophobic to hydrophilic to achieve a higher surface tension on the surface of the carbon-carbon composite material.

7. The process according to claim 1, wherein a ballistic water contact angle of the surface of the carbon-carbon composite material is reduced from 50 degrees- 70 degrees prior to the plasma surface treatment to 2 degrees-20 degrees post plasma surface treatment.

8. A carbon-carbon composite material treated with a plasma surface treatment prior to applying an oxidation inhibiting composition, the treatment comprising:
modifying a surface of the carbon-carbon composite material to increase a hydrophilic surface functionality;
applying a plasma surface treatment to the carbon-carbon composite material;
infiltrating the carbon-carbon composite with an oxidation inhibiting composition; and
heating the carbon-carbon composite at a predetermined temperature sufficient to form a deposit from the oxidation inhibiting composition in at least some pores of the carbon-carbon composite.

9. The carbon-carbon composite material according to claim 8, wherein the plasma surface treatment is applied to the carbon-carbon composite prior to application of the oxidation inhibiting composition.

10. The carbon-carbon composite material according to claim 9, wherein both argon and air are employed in the plasma surface treatment.

11. The carbon-carbon composite material according to claim 8, further comprising:
exposing the surface of the carbon-carbon composite material for one to five minutes to an argon gas; and
exposing the surface of the carbon-carbon composite material for five to twenty minutes to air.

12. The carbon-carbon composite material according to claim 8, wherein the plasma surface treatment is combined with multiple oxidation inhibiting composition infiltration steps and vacuum processes to accelerate the oxidation inhibiting composition solution coverage on open pores of the surface and enhance oxidation resistance of the carbon-carbon composite material.

13. The carbon-carbon composite material according to claim 8, wherein a ballistic water contact angle of the surface of the carbon-carbon composite material is reduced from 50 degrees-70 degrees prior to the plasma surface treatment to 2 degrees-20 degrees post plasma surface treatment.

14. A process for treating a gas turbine engine component made from a carbon-carbon composite material comprising:
modifying a surface of the carbon-carbon composite material to increase a hydrophilic surface functionality;
applying a plasma surface treatment to the carbon-carbon composite material;
infiltrating the carbon-carbon composite component with an oxidation inhibiting composition; and
heating the carbon-carbon composite component at a predetermined temperature sufficient to form a deposit from the oxidation inhibiting composition in at least some pores of the carbon-carbon composite component.

15. The process of claim 14, wherein the plasma surface treatment is applied to the carbon-carbon composite prior to application of the oxidation inhibiting composition.

16. The process of claim 14, further comprising:
exposing the surface of the carbon-carbon composite material component for one to five minutes to an argon gas; and
exposing the surface of the carbon-carbon composite material component for five to twenty minutes to air.

17. The process of claim 14, further comprising:
reducing a ballistic water contact angle of the surface of the carbon-carbon composite material component from 50 degrees-70 degrees prior to the plasma surface treatment to 2 degrees-20 degrees post plasma surface treatment.

18. The process of claim 14, further comprising:
combining the plasma surface treatment with multiple oxidation inhibiting composition infiltration steps and vacuum processes to accelerate the oxidation inhibiting composition solution coverage on open pores of the surface and enhance oxidation resistance of the carbon-carbon composite material.

19. The process of claim 14, further comprising:
employing both argon and air in the plasma surface treatment.

20. The process of claim 14, further comprising:
drying the carbon-carbon composite material component.
